(19) United States
(12) Patent Application Publication
(10) Pub. No.: US 2004/0259595 A1
(43) Pub. Date: Dec. 23, 2004

(54) Method for implementing speech channel exchange in the call succession of the mobile communication system

(76) Inventor: Ganghua Yang, Guangdong (CN)

Correspondence Address: HARNESS, DICKEY & PIERCE, P.L.C., P.O. BOX 828, BLOOMFIELD HILLS, MI, 48303, US

(21) Appl. No.: 10/479,317

(22) PCT Filed: Apr. 8, 2002
(86) PCT No.: PCT/CN02/00240

(30) Foreign Application Priority Data
May 30, 2001 (CN) 01113018.0

(51) Int. Cl. H04M 1/66; H04Q 7/20

(52) U.S. Cl. 455/561; 455/456.1; 455/411; 455/433

(57) ABSTRACT

Disclosed is a method for implementing voice channel switching during calling proceeding in a mobile communication system, comprising the steps of: adding a switching network in a Base Station Controller (BSC); authenticating the calling mobile station, determining the location area of the called mobile station and initiating paging for the called mobile station by the mobile communication system; obtaining the information of the coverage area of the Base Transceiver Station (BTS) corresponding to the calling mobile station and that of the BTS corresponding to the called mobile station, and judging whether the calling party and the called party locate in the coverage areas of the BTSs managed by the same BSC; if so, implementing voice channel connection through the switching network added in the BSC; otherwise implementing the voice channel connection through mobile exchanges. With this invention, roundabout voice paths can be reduced, meanwhile data flow and transmission delay between subsystems of the mobile system can be decreased.

### BACKGROUND OF THE INVENTION

In the prior mobile communication systems, such as Global System for Mobile Communication (GSM), Code Division Multiple Access (CDMA) system, Wideband Code Division Multiple Access (WCDMA) system and Code Division Multiple Access 2000 (CDMA2000) system, the voice channel switching during the calling proceeding is implemented by the mobile exchanges, such as Mobile Switching Center (MSC) in GSM system, Core Network (CN) in WCDMA system and MSC in CDMA2000 system. Even if a calling Mobile Station (MS) and a called MS are located in the coverage areas of the Base Transceiver Stations (BTSs) managed by the same base station controller, such as BSC in GSM system, Radio Network Controller (RNC) in WCDMA system, and BSC in CDMA2000 system, mobile exchanges are still required for implementing the voice channel switching.

As shown in FIG. 1, the mobile calling proceeding in the coverage areas of BTSs managed by the same BSC in the GSM system comprises the following steps.

1) A Mobile Subscriber ISDN Number (MSISDN) is transmitted by Mobile Station a (MSa) to the MSC via Base Transceiver Station a (BTSa) and the BSC, thus the procedures including channel request, service request, authentication request and channel assignment are implemented.

2) A request is sent by MSC to a Host Location Register/Authentication Center (HLR/AUC) to retrieve a Mobile Station Roaming Number (MSRN);

3) The MSRN is provided by Visit Location Register (VLR), and returned back to the MSC;

4) After analyzing MSRN by MSC to know the called party is a local user, a Store and Forward Information of Calling (S. F. I. C.) is transmitted to VLR;

5) A paging request is sent by VLR to MSC;

6) A paging request is sent by MSC to BSC and BTSb, and MSb is found;

7) The voice channel switching is implemented in MSC.

The above voice channel switching during the calling proceeding is implemented in MSC. The roundabout voice paths from BTS to BSC and from BSC to MSC are introduced, and unnecessary data flow and transmission delay between subsystems are increased. Particularly, in some transmission systems, such as satellite transmission system, more delay and error codes are introduced therein. The delay of dual skips is about 540 ms, thereby the rental of the transmission links may be increased.

An object of the invention is to provide a method for implementing voice channel switching during the calling proceeding in a mobile communication system. With this method, the roundabout voice paths can be reduced, the data flow and transmission delay between subsystems of the mobile system can be decreased, and the rental of the transmission links can be saved.

### SUMMARY OF THE INVENTION

In order to accomplish the above object, a method for implementing voice channel switching during calling proceeding in a mobile communication system according to the invention comprises the steps of: a. adding switching networks in base station controllers; b. authenticating the calling mobile station, determining the location area of the called mobile station and initiating paging for the called mobile station by the mobile communication system; c. obtaining the information of the coverage area of the BTS corresponding to the calling mobile station and that of the BTS corresponding to the called mobile station, and judging whether the calling party and the called party locate in the coverage areas of the BTSs managed by the same base station controller; d. if the calling party and the called party locate in the coverage areas of the BTSs managed by the same base station controller, implementing voice channel connection through the switching network added in the base station controller; e. if the calling party and the called party locate in the coverage areas of the BTSs managed by different base station controllers, implementing the voice channel connection through mobile exchanges.

In the above-mentioned method, when the mobile communication system is a GSM system, in step c, the information of the coverage area of the BTS corresponding to the calling mobile station is obtained through cell identification number carried in the messages sent by the calling mobile station, and whether the calling party and the called party locate in the coverage areas of the BTSs managed by the same base station controller is judged by the MSC or the base station controller.

In the above-mentioned method, the transmission system supporting net-like structure can be used as the interface between the BTS and the base station controller in said GSM system, and the base station controller has a structure supporting said interface to employ complete net-like transmission.

In the above-mentioned method, when the mobile communication system is a WCDMA system, in step c, the information of the coverage area of the BTS corresponding to the calling mobile station is obtained through cell identification number carried in the messages sent by the calling base station, and whether the calling party and the called party locate in the coverage areas of the BTSs managed by the same base station controller is determined by the core switching network or the RNC.

In this invention, after implementing the prior normal call procedures, whether the calling party and the called party locate in the coverage areas of the BTSs managed by the same base station controller is determined. If the calling party and the called party locate in the coverage areas of the BTSs managed by the same base station controller, the voice channel switching is implemented by the switching network added in the base station controller. In this way, on one hand, the roundabout voice paths and the data flow between the subsystems of the mobile communication systems can be reduced, thereby the rental for transmission is reduced. Particularly, it is more significant for the systems with large data flow, such as WCDMA, CDMA2000, and the like; on the other hand, the delay and affection to the voice quality caused by the unnecessary transmission are reduced. The voice channel switching for both the calling party and the called party belonging to the same base station controller is implemented in the base station controller via the transmission systems (such as the complete net-like network of the satellite transmission) which supports the net-like structure, the unnecessary dual-skip delay is prevented, and the transmission links are saved.

### BRIEF DESCRIPTION OF THE DRAWINGS

FIG. 1 is a schematic diagram illustrating flow of calling between mobile stations under the same BSC in the prior GSM system.

FIG. 2 is a schematic diagram illustrating the flow of the invention.

FIG. 3 is a schematic diagram illustrating the flow of the invention applied in GSM system.

FIG. 4 is a schematic diagram illustrating the GSM system according to the invention in which the change from dual-skip mode to single-skip mode of the satellite transmission is employed between BTS and BCS.

FIG. 5 is a schematic diagram illustrating the flow of the invention applied in WCDMA system.

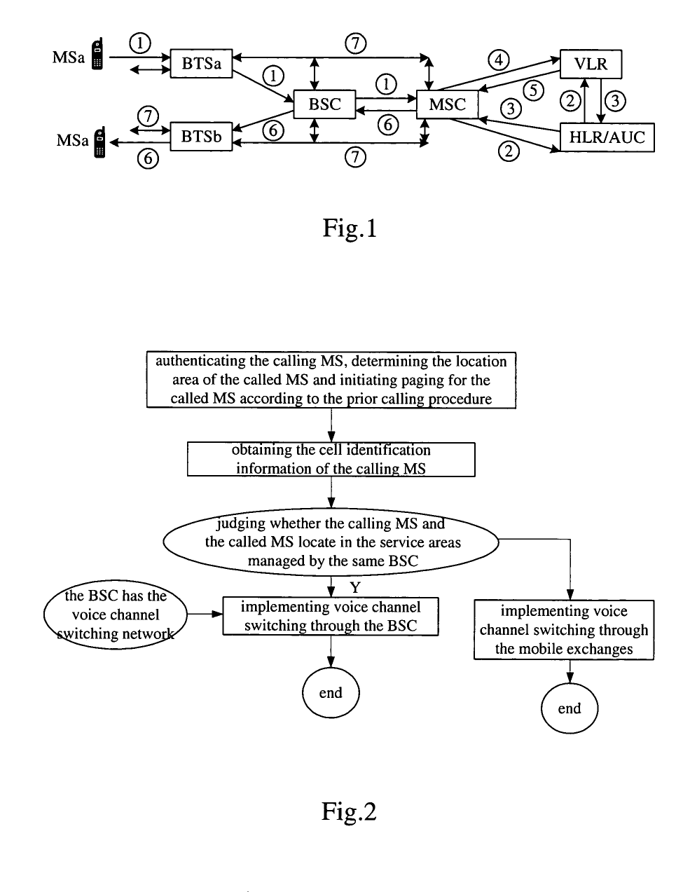

### DETAILED DESCRIPTION OF THE INVENTION

With reference to FIG. 2, a method for implementing voice channel switching during calling proceeding in a mobile communication system according to the invention comprises the steps of:

a. adding switching networks in base station controllers;

b. authenticating the calling mobile station, determining the location area of the called mobile station and initiating paging for the called mobile station by the mobile communication system;

c. obtaining the information of the coverage area of the BTS corresponding to the calling mobile station and that of the BTS corresponding to the called mobile station, and determining whether the calling party and the called party locate in the coverage areas of the BTSs managed by the same base station controller; and

d. if the calling party and the called party locate in the coverage areas of the BTSs managed by the same base station controller, implementing voice channel connection through the switching network added in the base station controller; or

e. if the calling party and the called party locate in the coverage areas of the BTSs managed by different base station controllers, implementing the voice channel connection through mobile exchanges.

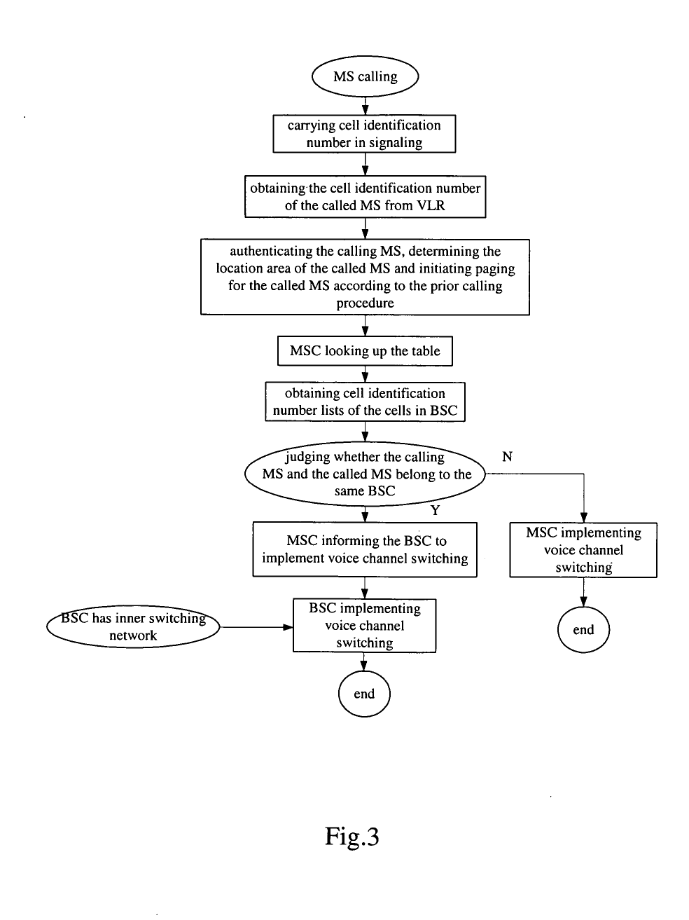

With reference to FIG. 3 again, when the above mobile communication system is GSM system, the messages sent by the calling MS includes the cell identification number of the calling party. In such a case, whether the calling party and the called party locate in the coverage areas of the BTSs managed by the same BSC is determined by MSC or the BSC. Meanwhile, the BSC involves the switching network supporting voice channel switching function.

In detail, the method comprises the steps as follows.

1. The cell identification numbers of both the calling MS and the called MS are obtained.

The coverage area of BTS is determined by the cell identification number. For a BS in all directions, there is only one cell, which corresponds to a cell identification number. In contrast, a directional BS has multiple cells, which correspond to a plurality of cell identification numbers, based on the different quantities of the sectors.

BSC supports control for a plurality of BTSs. In the management station of BSC, there are cell identification number tables for all BTSs managed by the present BSC.

In the flow procedure of the calling proceeding, the cell where the called MS is located is determined based on the cell identification number of BTS coverage area where the called MS is located which is obtained from VLR.

The cell identification number of the called MS can be obtained in the prior calling procedure.

The cell identification number of the calling MS can be obtained from the cell identification number information involved in the messages transmitted from the MS to the base station system.

2. Whether the calling MS and the called MS are located at the same BSC service region is determined by MSC or BSC.

After the authentication for the calling MS, the determination of the location area of the called MS and initiating paging to the called MS have been completed, a corresponding cell identification number table of BSC in the digital management station of BSC is checked by MSC. In this way, whether the current cell identification numbers of the calling MS and the called MS belong to the same BSC is determined, thereby whether BTS service regions where the calling MS and the called MS are located belong to the same BSC is determined, namely, whether the calling MS and the called MS are located at the same BSC service region is determined.

In order to reduce the impact for the prior network, the above function can be realized in BSC also.

3. BSC can support inner voice channel switching function.

BSC includes switching network supporting voice channel switching function, such as a time switcher or a space switcher. The structure and the capacity of the switching network are determined based on the statistic result showing the possibility that the calling MS and the called MS are located at the same BTS service region.

The switching network can be realized through switching net boards, switching net sheets, and the like. Also, the prior switching network in MSC may be used.

4. Proper voice channel switching manner is selected based on the determination result whether the calling MS and the called MS are located at the same BSC service region.

If the calling MS and the called MS are not located at the same BSC service region, the switching function of voice channels will be implemented according to the prior procedure, that is, the voice channel switching will be implemented by MSC.

In contrast, if the calling MS and the called MS are located at the same BSC service region, the BSC supporting the inner switching function will be informed to implement the voice channel switching function.

5. Complete net-like network transmission structure is supported at Abis interface.

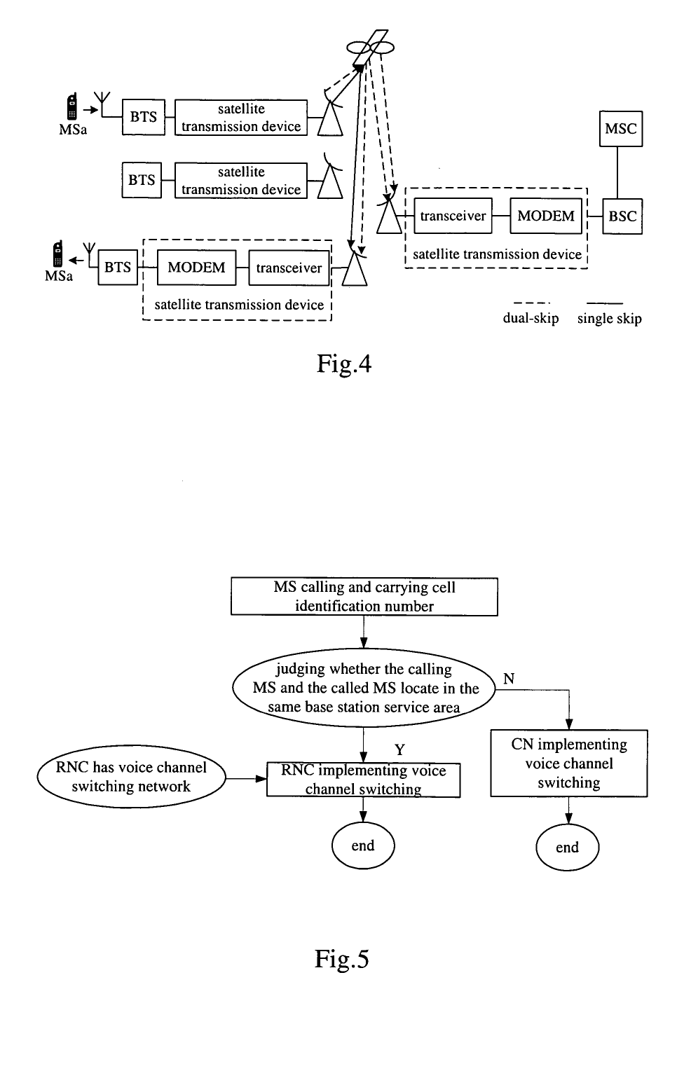

With reference to FIG. 4, for the transmission systems supporting the net-like structure used at Abis interface between BTS and BSC, for example, complete net-like network of the satellite transmission, after the calling proceeding has been completed, a direct connection can be established between two BTSs where the calling MS and the called MS are located, bypassing the BSC, thereby the dual-skip mode is changed to the single skip mode.

The voice link from MSa to MSb requires to arrive and leave the satellite two times (dual skips) from MSa to BSC and from BSC to MSb before the change. After the change, it only requires to arrive and leave the satellite once (single skip) from MSa to MSb. In this way, one half of the transmission bandwidth has been saved. After the dual skips mode is changed to the single skip mode, not only the transmission links are saved, but also the transmission delay is reduced. The delay of the dual-skip mode of the satellite transmission is about 540 ms, and it will be reduced one half for the single skip mode.

The BSC can support the net-like transmission structure at Abis interface. That is, when exactly knowing that the calling MS and the called MS are located at the present BSC during the calling procedure, the BSC informs the satellite transmission apparatus the information of BTSs where the calling MS and the called MS are located respectively. The switching from the star-like connection to the net-like connection can be performed by the satellite transmission apparatus to accomplish the direct connection of the voice channels.

In summary, the functions involved in the voice channel switching in the GSM system during the calling proceeding are as follows: the calling MS can send messages including the information of the cell identification number when initiating calling procedure; the MSC or the BSC can determine whether the current cell identification numbers of calling MS and the called MS belong to the same BSC; BSC involves switching network to implement the voice channel switching function; BSC supports the complete net-like transmission structure at Abis interface and can switch the dual-skip mode to the single skip mode.

Referring to FIG. 5, when the above mobile communication system is a WCDMA system, the cell identification information of the calling MS is carried in the messages sent by the calling MS. Whether the calling MS and the called MS are located at the BTS service regions managed by the same BSC is determined by the Core Switching Network (CN) or Radio Network Controller (RNC).

1. A method for implementing voice channel switching during calling proceeding in a mobile communication system, comprising the steps of:
a. adding switching networks in base station controllers;
b. authenticating the calling mobile station, determining the location area of the called mobile station and initiating paging for the called mobile station by the mobile communication system;
c. obtaining the information of the coverage area of the Base Transceiver Station (BTS) corresponding to the calling mobile station and that of the BTS corresponding to the called mobile station, and judging whether the calling party and the called party locate in the coverage areas of the BTSs managed by the same base station controller; and
d. if the calling party and the called party locate in the coverage areas of the BTSs managed by the same base station controller, implementing voice channel connection through the switching network added in the base station controller; or
e. if the calling party and the called party locate in the coverage areas of the BTSs managed by different base station controllers, implementing the voice channel connection through mobile exchanges.

2. The method of claim 1, wherein under the condition that said mobile communication system is a Global System for Mobile Communication (GSM), in step c, the information of the coverage area of the BTS corresponding to the calling mobile station is obtained through cell identification number carried in the messages sent by the calling mobile station, and whether the calling party and the called party locate in the coverage areas of the BTSs managed by the same base station controller is judged by the Mobile Switching Center (MSC) or the base station controller.

3. The method of claim 2, wherein the transmission system supporting net-like structure is used as the interface between the BTS and the base station controller in said GSM system, and the base station controller has a structure supporting said interface to employ complete net-like transmission.

4. The method of claim 1, wherein under the condition that said mobile communication system is a Wideband Code Division Multiple Access (WCDMA) system, in step c, the information of the coverage area of the BTS corresponding to the calling mobile station is obtained through cell identification number carried in the messages sent by the calling base station, and whether the calling party and the called party locate in the coverage areas of the BTSs managed by the same base station controller is judged by the core switching network or the Radio Network Controller (RNC).
